(19) United States
(12) Patent Application Publication
(10) Pub. No.: US 2021/0299558 A1
(43) Pub. Date: Sep. 30, 2021

(54) GAME DEVICE, METHOD, AND PROGRAM

(71) Applicant: JVCKENWOOD Corporation, Yokohama-shi (JP)

(72) Inventors: Yuya TAKEHARA, Yokohama-shi (JP); Hideki AIBA, Yokohama-shi (JP); Hisashi OKA, Yokohama-shi (JP); Ryouji HOSHI, Yokohama-shi (JP); Shingo KIDA, Yokohama-shi (JP); Yincheng YANG, Yokohama-shi (JP); Hideya TSUJII, Yokohama-shi (JP); Daisuke HACHIRI, Yokohama-shi (JP); Ryotaro FUTAMURA, Yokohama-shi (JP)

(21) Appl. No.: 17/211,630

(22) Filed: Mar. 24, 2021

(30) Foreign Application Priority Data
Mar. 26, 2020 (JP) 2020-055348

(51) Int. Cl. A63F 13/44; A63F 13/428; A63F 13/45

(52) U.S. Cl. CPC A63F 13/44; A63F 2300/638; A63F 13/45; A63F 13/428

(57) ABSTRACT

A game device includes a reception unit that is configured to receive operation information created when a user performs an operation on an input device while a game progresses, a determination unit that is configured to determine whether an operation of starting measurement of the degree of concentration has been performed on the basis of the operation information received by the reception unit, and a derivation unit that is configured to start measuring the degree of concentration if the determination unit determines that the operation of starting measurement of the degree of concentration has been performed and is configured to derive the degree of concentration of the user on the basis of an operation performed by the user during the started measurement of the degree of concentration.

### CROSS-REFERENCE TO RELATED PATENT APPLICATIONS

This application claims priority from Japanese Application No. 2020-055348, filed on Mar. 26, 2020, the contents of which are incorporated by reference herein in its entirety.

### BACKGROUND OF THE INVENTION

### Field of the Invention

The present invention relates to a game device, a method, and a program.

### Description of Related Art

A technique for games to prevent players from being excessively enthusiastic about playing games is known (e.g., refer to Patent Document 1). In this technique, a display unit displays figures having a predetermined size at short time intervals. If an operation instruction of a player received by a reception unit before a next figure is displayed matches an operation instruction corresponding to the direction indicated by the figure being displayed, an updating unit determines that the operation instruction is successful, and updates a success rate indicating statistical information stored in a storage unit. If a change of a success rate acquired by an acquisition unit significantly increases, a warning unit estimates that the player is too close to the screen, and if the change of success rate significantly decreases, the warning unit estimates that the player is fatigued. The warning unit gives a warning with the estimation result. A plurality of figures are displayed on the screen only for a predetermined time period. That is, a “success” is determined when an operation that matches a displayed figure is made, and a warning is issued to the user on the basis of a change of a success rate.

### PATENT DOCUMENTS

[Patent Document 1] Japanese Unexamined Patent Application, First Publication No. 2011-104170

### SUMMARY OF THE INVENTION

A success rate is indicated by an index in which both “whether a user is aware of display of a figure” and “correctness of a reaction” are mixed. Thus, there is concern that it is not possible to correctly measure fatigue when a user fails to be aware of display of a figure, or the like. As a result that it is not possible to correctly measure fatigue, there is concern that the user will continue playing the game with fatigue and shortage of concentration.

An aspect of the embodiment of present invention is a game device including a reception unit that is configured to receive operation information created when a user performs an operation on an input device while a game progresses, a determination unit that is configured to determine whether an operation of starting measurement of the degree of concentration has been performed on the basis of the operation information received by the reception unit, and a derivation unit that is configured to start measuring the degree of concentration if the determination unit determines that the operation of starting measurement of the degree of concentration has been performed and derives the degree of concentration of the user on the basis of an operation performed by the user during the started measurement of the degree of concentration.

An aspect of embodiment of the present invention is a method including receiving operation information created when a user performs an operation on an input device while a game progresses, determining whether an operation of starting measurement of the degree of concentration has been performed on the basis of the operation information, and starting measuring the degree of concentration if it is determined that the operation of starting measurement of the degree of concentration has been performed and deriving the degree of concentration of the user on the basis of an operation performed by the user during the started measurement of the degree of concentration.

An aspect of the embodiment of present invention is a non-transitory computer readable medium, storing a program causing a computer to execute receiving operation information created when a user performs an operation on an input device while a game progresses, determining whether an operation of starting measurement of a degree of concentration has been performed on the basis of the operation information and starting measuring a degree of concentration if it is determined that the operation of starting measurement of a degree of concentration has been performed and deriving a degree of concentration of the user on the basis of an operation performed by the user during the started measurement of a degree of concentration.

According to the embodiment of present invention, it is possible to provide a game device, a method, and a program that enable the degree of concentration to be measured while a game progresses.

### BRIEF DESCRIPTION OF THE DRAWINGS

FIG. 1 is a diagram illustrating a configuration example of a game system according to an embodiment of the present invention.

FIG. 2 is a diagram illustrating an example of a game device according to the present embodiment.

FIG. 3 is a block diagram illustrating an example of the game device according to the present embodiment.

FIG. 4 is a diagram illustrating Example 1 of a predetermined operation required for a user.

FIG. 5 is a diagram illustrating Example 2 of a predetermined operation required for a user.

FIG. 6 is a diagram illustrating Example 3 of a predetermined operation required for a user.

FIG. 7 is a diagram illustrating an example of information output by an output device.

FIG. 8 is a diagram illustrating an example of a game server according to the present embodiment.

FIG. 9 is a flowchart showing an example of an operation of the game system according to the present embodiment.

FIG. 10 is a block diagram illustrating an example of a game device according to a modified example of the present embodiment.

FIG. 11 is a flowchart showing an example of an operation of a game system according to the modified example of the present embodiment.

### DETAILED DESCRIPTION OF THE INVENTION

Next, a game device, a method, and a program according to the present embodiment will be described with reference to the drawings. The embodiments described below are merely examples, and an embodiment to which the present invention is applied is not limited to the following embodiments.

Further, the same reference numerals are used for constituent elements having the same functions in all of the drawings for describing the embodiments, and repetitive description thereof will be omitted.

In addition, “on the basis of XX” in the present specification means “on the basis of at least XX” and includes a case on tie basis of another element in addition to “XX.” In addition, “on the basis of XX” is not limited to a case in which XX is directly used, and also includes a case on the basis of an arithmetic operation or in which processing is performed on XX. “XX” is any element (e.g., any information).

### Embodiment

(Game System)

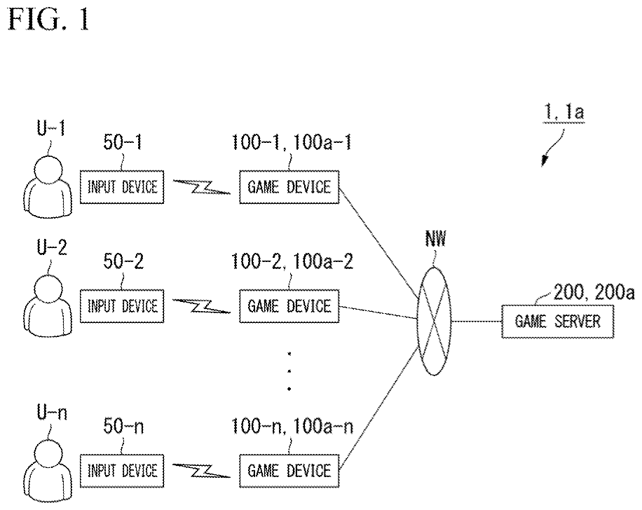

FIG. 1 is a diagram illustrating a configuration example of a game system according to an embodiment of the present invention. In FIG. 1, the game system 1 includes an input device 50-1, an input device 50-2, . . . , and an input device 50-n, (n is an integer satisfying n>0), a game device 100-1, a game device 100-2, . . . , and a game device 100-n, and a game server 200.

The input device 50-1, the input device 50-2, . . . , and the input device 50-n are connected to the game device 100-1, the game device 100-2, . . . , and the game device 100-n, respectively. As an example, a case in which the input device 50-1, the input device 50-2, . . . , and the input device 50-n are wirelessly connected to the game device 100-1, the game device 100-2, . . . , and the game device 100-n, respectively, will be described below. However, the input device 50-1, the input device 50-2, . . . , and the input device 50-n may be connected to the game device 100-1, the game device 100-2, . . . , and the game device 100-n, respectively, by wires.

In addition, the game device 100-1, the game device 100-2, . . . , and the game device 100-n communicate with the game server 200 via a network NW. However, the game device 100-1, the game device 100-2, . . . , and the game device 100-n may be connected to the game server 200 without passing through the network NW. As an example, description of a case in which the game device 100-1, the game device 100-2, . . . , and the game device 100-n communicate with the game server 200 via the network NW by wires will be continued below. However, the game device 100-1, the game device 100-2, . . . , and the game device 100-n may wirelessly communicate with the game server 200 via the network NW.

The network NW includes, for example, the Internet, a wide area network (WAN), a local area network (LAN), provider equipment, a radio base station, and the like.

The input device 50-1 is connected to the game device 100-1 by wires or wirelessly. A user U-1 uses the game device 100-1 and the input device 50-1. The input device 50-2 is connected to the game device 100-2 by wires or wirelessly. A user U-2 uses the game device 100-2 and the input device 50-2. The input device 50-n is connected to the game device 100-n by wires or wirelessly. A user U-n uses the game device 100-n and the input device 50-n.

Hereinafter, any game device among the game device 100-1 to the game device 100-n will be described as a game device 100. In addition, an input device connected to the game device 100 will be described as an input device 50, and a user using the game device 100 and the input device 50 will be described as a user U. In addition, a description of a case in which the input device 50 is wirelessly connected to the game device 100 will be continued.

The user U performs an operation on the input device 50 while a game progresses. Here, an example of the game is a game in which a participant operates a character (player character) assigned to him or her such as in a role-playing game (RPG). The input device 50 detects an operation performed by the user U and creates instruction information including the user ID and information indicating the content of the operation on the basis of the detected operation. The input device 50 outputs the created instruction information to the game device 100. The game device 100 transmits the instruction information to the game server 200 upon receiving the instruction information output by the input device 50. The game server 200 receives the instruction information transmitted by the game device 100 and reflects the content of the operation in the game on the basis of the information indicating the content of the operation included in the received instruction information. The game server 200 transmits game information including game data in which the content of the operation is reflected to the game device 100 that has transmitted the instruction information. The game device 100 receives the game information transmitted by the game server 200 and outputs an image and sound of the game on the basis of the game data included in the received game information.

In addition, the game device 100 determines whether an operation of starting measurement of the degree of concentration has been performed on the basis of the received instruction information. Here, the degree of concentration is an index indicating the degree of the user U working and concentrating on a game. As the degree at which the user U immerses himself or herself in the game becomes higher, the degree of concentration becomes higher. On the other hand, even if the user U is immersing himself or herself in the game, if the speed or accuracy of an operation of the user U becomes lower due to (physical or mental) fatigue, the degree of concentration becomes lower. Further, the degree of concentration may be regarded as the degree of fatigue that is an index indicating the degree of fatigue of the user U.

The user U is informed of which operation is essential to the user U or which operation brings a beneficial result to the user U while the game progresses. However, it is not necessary to inform the user U of which is an “operation to start measurement.” If it is determined that an operation to start measurement of the degree of concentration has been performed, the game device 100 starts measuring the degree of concentration.

The user U continues the game by performing operations with the input device 50. The input device 50 detects the operations performed by the user U and creates instruction information on the basis of the detected operations. The input device 50 outputs the created instruction information to the game device 100.

The game device 100 receives the instruction information output by the input device 50. The game device 100 derives the degree of concentration on the basis of information indicating the content of the operations included in the received instruction information. The game device 100 outputs information indicating the derived degree of concentration.

Each of the input device 50, the game device 100, and the game server 200 included in the game system 1 will be sequentially described below.

(Input Device 50)

An example of the input device 50 includes a left grip part and a right grip part. The user U grips the left grip pan with the left hand and the right grip part with the right hand to operate the input device 50. Direction keys and operation buttons are provided on the top surface of the housing of the input device 50. Furthermore, a touch pad is provided in a flat area between the direction keys and the operation buttons provided on the top surface of the housing of the input device 50. The input device 50 detects an operation performed by the user U and creates instruction information including the user ID and information indicating the content of the operation on the basis of the detected operation. The input device 50 transmits the created instruction information wirelessly to the game device 100.

(Game Device 100)

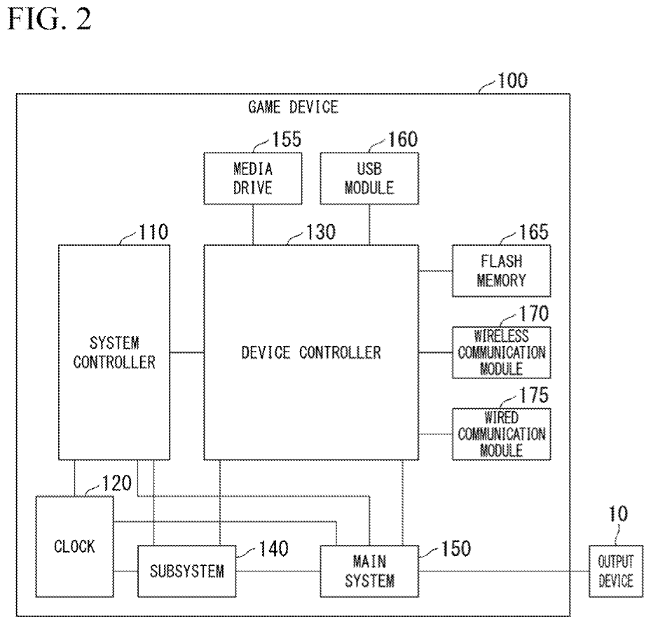

FIG. 2 is a diagram illustrating an example of the game device according to the present embodiment. In FIG. 2, a hardware configuration of the game device 100 is mainly illustrated.

The game device 100 includes a system controller 110, a clock 120, a device controller 130, a media drive 155, a USB module 160, a flash memory 165, a wireless communication module 170, a wired communication module 175, a subsystem 141), and a main system 150.

The main system 150 includes a main central processing unit (CPU), a memory, a main controller, a graphics processing unit (GPU), and the like. The CPU mainly executes arithmetic operation processing of a game program. These functions may be configured in a system-on-chip to be formed on one chip. The main CPU executes game programs. The main system 150 outputs a result of arithmetic operation processing of a game program and an execution result of the game program to an output device 10. An example of the output device 10 is a monitor with a display that outputs images and a speaker that outputs sound.

The subsystem 140 includes a sub CPU, a memory, a memory controller, and the like. The subsystem 140 neither includes a GPU nor executes a game program. The sub CPU operates even while the main CPU is in a standby state, and limits processing functions of operations to reduce power consumption to a low level.

The system controller 110 detects a power-on instruction or a power-off instruction when the user U presses a main power button (not illustrated). The system controller 110 turns on or off power of the game device 100 on the basis of the detected power-on instruction or power-off instruction.

An example of the clock 120 is a real-time clock. The clock 120 generates current day and time information and outputs the generated current day and time information to the system controller 110, the subsystem 140, and the main system 150.

An example of the device controller 130 is configured by a large-scale integrated circuit (LSI) and executes transfer of information between devices. The device controller 130 is connected to devices such as the system controller 110, the media drive 155, the USB module 160, the flash memory 165, the wireless communication module 170, the wired communication module 175, the subsystem 140, the main system 150, and the like. The device controller 130 absorbs a difference in electrical characteristics and a difference in data transfer speed between the devices, and controls timings of data transfer.

The media drive 155 is loaded with a ROM medium in which application software such as a game and license information are recorded. The media drive 155 reads the program, data, and the like from the loaded ROM medium. The ROM medium is a recording medium dedicated to reading such as an optical disc, a magneto-optical disc, or the like.

The USB module 160 is a module connecting to an external apparatus with a USB cable. The USB module 160 may be connected to a device such as an auxiliary storage device (not illustrated) or a camera (not illustrated) with a USB cable.

The flash memory 165 is an auxiliary storage device that configures an internal storage.

The wireless communication module 170 communicates with an external apparatus such as the input device 50 wirelessly in a wireless communication method such as a wireless LAN, Bluetooth (registered trademark), or LTE (registered trademark).

The wired communication module 175 is connected to an external apparatus and communicates with the connected input device 50 by wires.

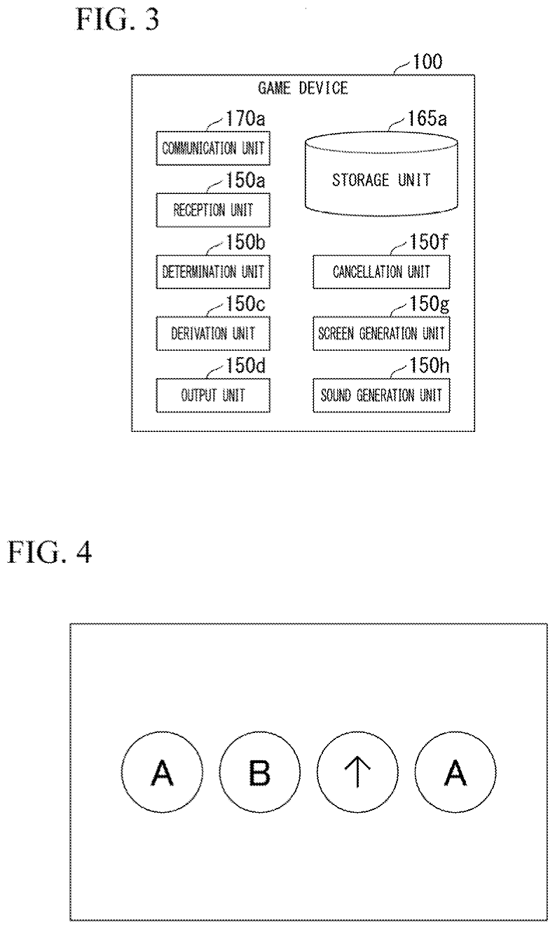

FIG. 3 is a block diagram illustrating an example of the game device according to the present embodiment. In FIG. 3, a functional configuration of the game device 100 is mainly illustrated.

The game device 100 includes, for example, a communication unit 170a, a reception unit 150a, a determination unit 150b, a derivation unit 150c, an output unit 150d, a cancellation unit 150f, a screen generation unit 150g, a sound generation unit 150h, and a storage unit 165a.

The communication unit 170a is realized by, for example, the wireless communication module 170 and the wired communication module 175. The communication unit 170a communicates with an external communication device such as the input device 50. In addition, the communication unit 170a communicates with an external communication device such as the game server 200 via the network NW. The communication unit 170a communicates in a wireless communication method, for example, a wireless LAN, Bluetooth (registered trademark), LTE (registered trademark), or the like. The communication unit 170a receives instruction information transmitted by the input device 50. The communication unit 170a transmits the instruction information to the game server 200. The communication unit 170a receives game information transmitted by the game server 200.

An example of the storage unit 165a is realized by the flash memory 165. The storage unit 165a may be realized by a hard disk drive (HDD), a random access memory (RAM), a read only memory (ROM), or the like. The storage unit 165a saves data to be used by game programs. The data to be used by game programs, and the like may be stored on a cloud.

The reception unit 150a, the determination unit 150b, the derivation unit 150c, the output unit 150d, the cancellation unit 150f, the screen generation unit 150g, and the sound generation unit 150h are realized by, for example, the main system 150 executing a computer program (software) saved in the storage unit 165a. In addition, some or all of these functional units may be realized by hardware (circuit unit including circuitry) such as an LSI, an ASIC, an FPGA, or a GPU, or may be realized by collaboration of software and hardware. The computer program may be saved in a storage device such as an HDD or a flash memory in advance, may be saved in a detachable storage medium such as a DVD or a CD-ROM, or may be installed by loading a storage medium in a drive device.

The reception unit 150a receives instruction information received by the communication unit 170a. The reception unit 150a receives game information received by the communication unit 170a.

The determination unit 150b determines whether a predetermined operation has been performed on the basis of information indicating content of the operation included in the instruction information received by the reception unit 150a. The determination unit 150b determines whether measurement of the degree of concentration is to be started if it is determined that the operation corresponding to the information indicating the content of the operation included in the instruction information corresponds to the predetermined operation. Examples of the predetermined operation include an operation that would hinder playing of the game if it were not performed by the user U, and an operation that would result in a beneficial result in playing of the game if it were performed by the user U.

More specifically, examples of the predetermined operation include an operation to open a box containing items, an operation of opening a field of items owned by the user character, an operation to use a specific item, an operation to load a magazine of a firearm, an operation to switch a weapon and equipment to be used, and the like. A predetermined operation is set for each game. The user U may set the operation before starting a game.

In addition, the determination unit 150b may determine whether the information indicating the content of the operation included in the instruction information received by the reception unit 150a corresponds to an operation to cancel the measurement of the degree of concentration.

If the determination unit 150b determines to start measuring the degree of concentration, the derivation unit 150c starts measuring the degree of concentration of the user U while the game progresses. After starting measuring the degree of concentration, the derivation unit 150c determines whether an operation performed by the user U corresponds to the predetermined operation required for the user U in a scene of the game. The derivation unit 150c derives the degree of concentration of the user U on the basis of the operation performed by the user U corresponding to the predetermined operation.

An example of the predetermined operation required for the user U in a scene of the game will be described. Here, the description will be simplified for the sake of convenience of description.

FIG. 4 is a diagram illustrating Example 1 of the predetermined operation required for the user U. Here, it is assumed that a box needs to be opened to acquire an item to allow the player to progress in a game. Alternatively, it is assumed that opening a box to acquire an item is beneficial to the player to progress in a game. As a rule of the game, it is assumed that no item will be acquired if the operation is not performed within a certain time period. In addition, it is assumed that the chance of acquiring a useful item becomes higher as the operation is performed more quickly. That is, there is an incentive for the user U to perform an operation of opening the box as quickly as possible in accordance with rules of the game.

For example, it may be set that after the measurement of the degree of concentration is started, letters or symbols pop out from the box when the user U performs the operation of opening the box containing an item. In the case of FIG. 4, the game device 100 causes the output device 10 to display letters or symbols such as “A,” “B,” “1,” and “A,” from the left. The user U is required to input the letters or symbols in order with reference to the letters or symbols displayed on the output device 10. The degree of concentration (degree of fatigue) of the user U can be reliably measured by measuring the operation to give an incentive to the user U when performing the operation of opening the box as quickly as possible.

The derivation unit 150c acquires display time information that is information indicating the time at which the letters or symbols were displayed on the output device 10 from the clock 120. In addition, after the letters or symbols are displayed on the output device 10, the derivation unit 150c acquires reception time information that is information indicating the time at which the reception unit 150a received operation instruction information from the clock 120. The derivation unit 150c derives the time elapsed from the display time to the reception time on the basis of the display time information and the reception time information to acquire a reaction speed. In addition, the derivation unit 150c may derive the time elapsed from when input of the letters or symbols was started to when input of all of the letters or symbols was finished to acquire a reaction speed.

In addition, the derivation unit 150c determines whether the letters or symbols input by the user U operating the input device 50 match the letters or symbols output by the output device 10. The derivation unit 15kc derives an accuracy such as a correct answer rate on the basis of the determination result. The derivation unit 150c may derive a failure rate on the basis of the determination result.

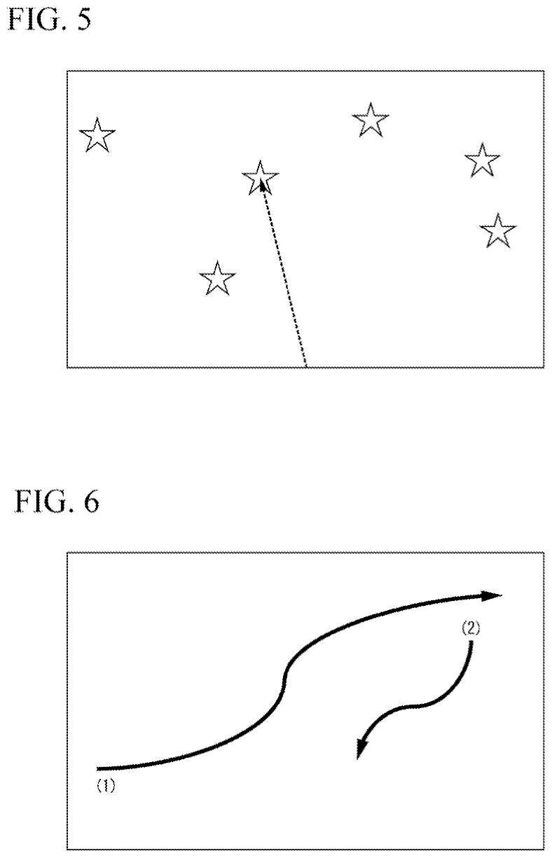

FIG. 5 is a diagram illustrating Example 2 of the predetermined operation required for the user U. Here, it is assumed that all targets placed at random need to be shot to allow a game to progress. Alternatively, it is assumed that shooting all of the targets placed at random is beneficial to the player to progress in a game. As a rule of the game, it is assumed that no benefits will be acquired if the operation is not performed within a certain time period. Alternatively, it is assumed that the chance of acquiring a useful benefit becomes higher as shooting is performed more quickly. That is, there is an incentive for the user U when performing the operation to shoot all of the targets placed at random as quickly as possible in accordance with rules of the game.

For example, it may be set that, after the measurement of the degree of concentration is started, star-shaped targets are displayed at random when the user U performs the operation of loading a magazine of a firearm. In the case of FIG. 5, the game device 100 causes the output device 10 to display star-shaped targets at random. The user U is required to perform the operation of shooting the targets with reference to the targets displayed on the output device 10 to allow the game to progress. The degree of concentration (degree of fatigue) of the user U can be reliably measured by measuring the operation for which there is an incentive for the user U to perform the operation as quickly as possible.

The derivation unit 150c acquires display time information that is information indicating the time at which the targets were displayed on the output device 10 from the clock 120. In addition, after the targets are displayed on the output device 10, the derivation unit 150c acquires reception time information that is information indicating the time at which the reception unit 150a received operation instruction information from the clock 120. The derivation unit 150c derives the time elapsed from the display time to the reception time on the basis of the display time information and the reception time information to acquire a reaction speed. In addition, the derivation unit 150c may derive the time elapsed from when shooting was started to when all of the targets were shot to acquire a reaction speed.

In addition, the derivation unit 150c determines whether the user U hit the targets output by the output device 10 by shooting them in operations of the input device 50. The derivation unit 150c derives an accuracy such as a correct answer rate on the basis of the determination result. Here, the derivation unit 150c may reflect the hits in the correct answer rate if the user hit the targets. The derivation unit 150c may derive a failure rate on the basis of the determination result.

FIG. 6 is a diagram illustrating Example 3 of the predetermined operation required for the user U. Here, it is assumed that a trajectory needs to be traced to progress in a game. Alternatively, it is assumed that tracing a trajectory is beneficial to the player to progress in the game. As a rule of the game, it is assumed that no benefits will be acquired if the player fails to trace the trajectory within a certain time period. Alternatively, it is assumed that the chance of acquiring a useful benefit becomes higher as the player traces the trajectory more quickly. That is, there is an incentive for the user U to perform the operation of tracing the trajectory as quickly as possible in accordance with the rules of the game.

For example, it may be set that, after the measurement of the degree of concentration is started, one or a plurality of trajectories are displayed when an operation of referring to a map is performed. In the case of FIG. 6, the game device 100 causes the output device 10 to display one or a plurality of trajectories. The user U performs an operation of tracing the one or plurality of trajectories with reference to the one or plurality of trajectories displayed on the output device 10. The degree of concentration (degree of fatigue) of the user U can be reliably measured by measuring the operation for which there is an incentive for the user U to perform the operation as quickly as possible.

The derivation unit 150c acquires display time information that is information indicating the time at which the trajectories were displayed on the output device 10 from the clock 120. In addition, after the trajectories are displayed on the output device 10, the derivation unit 150c acquires reception time information that is information indicating the time at which the reception unit 150a received operation instruction information from the clock 120. The derivation unit 150c derives the time elapsed from the display time to the reception time on the basis of the display time information and the reception time information to acquire a reaction speed. In addition, the derivation unit 150c may derive the time elapsed from when tracing was started to when tracing all of the trajectories was finished to acquire a reaction speed.

In addition, the derivation unit 150c determines whether the user U has traced the trajectories output by the output device 10 by performing the tracing operation with the input device 50. The derivation unit 150c derives an accuracy such as a correct answer rate on the basis of the determination result. Here, the derivation unit 150c may reflect a deviation in tracing of a trajectory in the correct answer rate. The derivation unit 15kc may derive a failure rate on the basis of the determination result.

The derivation unit 150c derives the degree of concentration of the user U on the basis of the reaction speed and the accuracy. For example, the derivation unit 150c derives the degree of concentration of the user U by performing a predetermined arithmetic operation on the basis of the reaction speed and the accuracy. Further, a ground for deviation is not limited to a reaction speed or accuracy, and the degree of concentration of the user U may be derived on the basis of agility in operations, such as the number of operations within a predetermined time period, or a time required for performing a predetermined number of operations. Returning to FIG. 3, a description will be continued.

The output unit 150d acquires information indicating a reaction speed and information indicating an accuracy from the derivation unit 150c. The output unit 150d displays the information indicating the reaction speed and the information indicating the accuracy on the output device 10. Here, the output unit 150d may store information indicating past reaction speeds in the storage unit 165a and display information indicating the time series of reaction speeds including the acquired information indicating the reaction speed and the information indicating the past reaction speeds. In addition, the output unit 150d may store information indicating a past accuracy in the storage unit 165a and display information indicating the time series of accuracy including the acquired information indicating the accuracy and the information indicating the past accuracy.

Furthermore, the output unit 150d acquires information indicating the degree of concentration from the derivation unit 150c. The output unit 150d displays information indicating that the user U is encouraged to take a rest on the basis of the acquired degree of concentration if the degree of concentration is less than a predetermined threshold value. The output unit 150d may display the information indicating that the user U is encouraged to take a rest on the basis of the acquired degree of concentration and the degrees of concentration of the past if the degree of concentration continuously decreases for a predetermined time period or longer. Further, the output unit 150d may perform processing on the basis of the above-described degree of concentration acquired from the derivation unit 150c without change, or may perform processing using a calculated representative value (statistical value) such as the mean, the median, the maximum, or the mode on the basis of the degree of concentration for a predetermined time period.

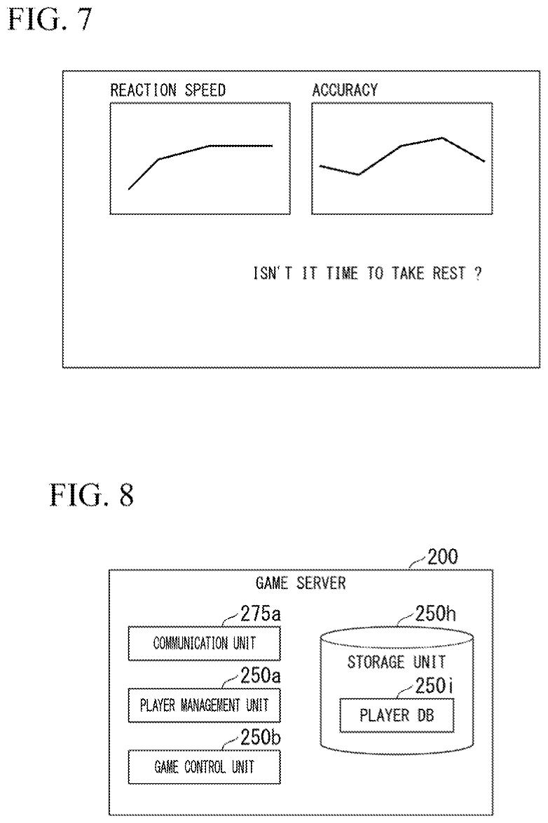

FIG. 7 is a diagram illustrating an example of information output by the output device.

In the example illustrated in FIG. 7, the output device 10 displays information indicating time series of a reaction speed, information indicating time series of accuracy, and information indicating that the user U is encouraged to take a rest. Instead of or along with the information indicating that the user U is encouraged to take a rest, information indicating that stopping the game is encouraged may be displayed on the output device 10.

The cancellation unit 150f cancels the measurement of the degree of concentration if the determination unit 150b determines that the instruction information received by the reception unit 150a corresponds to an operation of canceling the measurement of the degree of concentration. For example, the cancellation unit 150f may determine that there has not been an operation corresponding to the instruction information.

The screen generation unit 150g acquires the game information received by the reception unit 150a and generates images of the game controlled by the game server 200 on the basis of game data included in the acquired game information. The screen generation unit 150g outputs the generated images of the game to the output device 10.

The sound generation unit 150h acquires the game information received by the reception unit 150a and generates sound of the game controlled by the game server 200 on the basis of the game data included in the acquired game information. The sound generation unit 150h outputs the generated sound of the game to the output device 10.

(Game Server 200)

FIG. 8 is a diagram illustrating an example of the game server according to the present embodiment.

The game server 200 is realized by a device such as a personal computer, a server, a smartphone, a tablet computer, or an industrial computer. The game server 200 includes a communication unit 275a, a player management unit 250a, a game control unit 250b, and a storage unit 250h.

The communication unit 275a is realized by a communication module. The communication unit 275a communicates with an external communication device via the network NW. The communication unit 275a may communicate in a communication method, for example, a wired LAN, or the like. In addition, the communication unit 275a may communicate in a wireless communication method, for example, a wireless LAN, Bluetooth (registered trademark), LTE (registered trademark), or the like. Here, a case in which the communication unit 275a communicates in a communication method such as a wired LAN will be continuously described. The communication unit 275a holds communication information necessary to communicate with the game device 100 via the network NW. The communication unit 275a receives instruction information transmitted by the game device 100. The communication unit 275a acquires game information output by the game control unit 250b and transmits the acquired game information to the game device 100.

The storage unit 250h is realized by an HDD, a flash memory, a RAM, a ROM, or the like. The storage unit 250h stores a player DB 250i. The player DB 250i may be stored on a cloud.

The player DB 250i stores player IDs, passwords, game device addresses, and resources in association with each other. A player ID is identification information on a player of the game. A password is a sequence of letters, symbols, and numbers for authenticating a player. An example of a game device address is an IP address of the game device 100 to be used by a player. An ID of a device may be used as a game device address. A resource is the number of items owned by a player in the game, such as food, fuel, and wood.

The player management unit 250a and the game control unit 250b are realized by, for example, a hardware processor such as a CPU executing a computer program (software) saved in the storage unit 250h. In addition, some or all of these functional units may be realized by hardware (circuit unit including circuitry) such as an LSI, an ASIC, an FPGA, or a GPU, or may be realized by collaboration of software and hardware. The computer program may be saved in a storage device such as an HDD or a flash memory in advance, may be saved in a detachable storage medium such as a DVD or a CD-ROM, or may be installed by loading a storage medium in a drive device.

The player management unit 250a manages the user U of the game device 100. Upon receiving a log-in request included in operation information transmitted by the game device 100, the player management unit 250a refers to the player DB 250i stored in the storage unit 250h to authenticate the user U of the game device 100. If the user U is successfully authenticated, the player management unit 250a allows log-in of the game device 100.

The game control unit 250b executes a game program for managing progress of the game. The game control unit 250b acquires the instruction information received by the communication unit 275a to allow the game to progress on the basis of the user ID included in the acquired instruction information and information indicating the content of the operation. The game control unit 250b creates game data indicating a game status of the game device 100. The game control unit 250b creates game information including the created game data and destined for the game device 100 corresponding to the game data. The game control unit 250b outputs the created game information to the communication unit 275a.

(Operation of Game System 1)

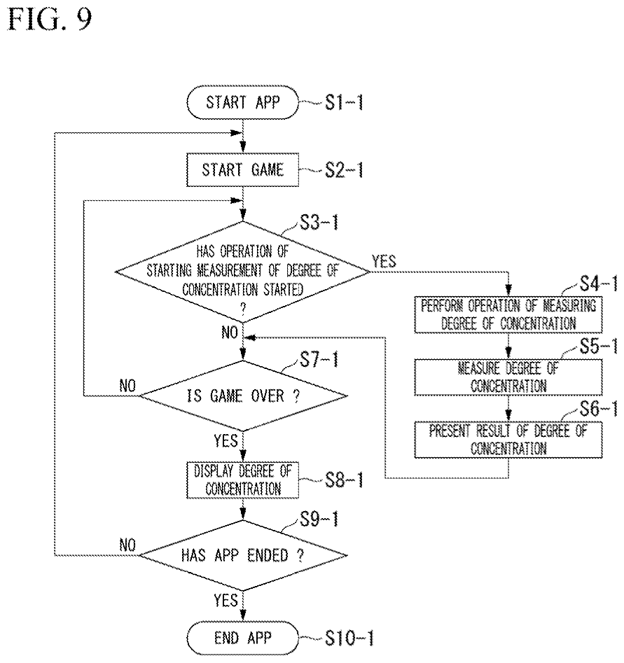

FIG. 9 is a flowchart showing an example of an operation of the game system according to the present embodiment.

In FIG. 9, an example of an operation of the game device 1X) is mainly shown. FIG. 9 shows an operation after log-in of the user U is completed.

(Step S1-1)

The game device 100 starts an app.

(Step S2-1)

The game device 100 starts a game.

(Step S3-1)

The reception unit 150a of the game device 100 receives instruction information received by the communication unit 170a. The determination unit 150b determines whether an operation of starting measurement of the degree of concentration has been performed on the basis of the instruction information received by the reception unit 150a.

(Step S4-1)

If the determination unit 150b of the game device 100 determines that measurement of the degree of concentration has started, the derivation unit 150c starts measuring the degree of concentration of the user U in a scene of the game. After starting measuring the degree of concentration, the derivation unit 150c determines whether an operation performed by the user U corresponds to the predetermined operation required for the user U in a scene of the game.

(Step S5-1)

The derivation unit 150c of the game device 100 acquires display time information and acquires reception time information on the basis of the operation performed by the user U corresponding to the predetermined operation. The derivation unit 150c derives the time elapsed from the display time to the reception time on the basis of the acquired display time information and reception time information to acquire a reaction speed.

The derivation unit 150c derives an accuracy such as a correct answer rate on the basis of the operation performed by the user U corresponding to the predetermined operation. The derivation unit 150c derives the degree of concentration of the user U on the basis of the reaction speed and the accuracy.

(Step S6-1)

The output unit 150d of the game device 100 acquires information indicating the degree of concentration from the derivation unit 150c. The output unit 150d displays the acquired information indicating the degree of concentration on the output device 10.

(Step S7-1)

The game device 100 determines whether the game is over. If the game is not over, the operation proceeds to step S3-1.

(Step S8-1)

The output unit 150d of the game device 100 acquires information indicating the reaction speed and the information indicating the accuracy from the derivation unit 150c. The output unit 150d displays the information indicating the reaction speed and the information indicating the accuracy on the output device 10. Furthermore, the output unit 150d acquires the information indicating the degree of concentration from the derivation unit 150c. If the degree of concentration is less than a predetermined threshold value on the basis of the acquired degree of concentration, the output unit 150d displays information indicating that the user U is encouraged to take a rest on the output device 10.

(Step S9-1)

The game device 1M determines whether an operation of ending the app has been performed. If an operation of ending the app has not been performed, the operation proceeds to step S2-1.

(Step S10-1)

The game device 100 ends the app if an operation of ending the app has been performed. Although a case in which the measurement result of the degree of concentration is displayed on the output device 10 in step S6-1 has been described in FIG. 9, the invention is not limited thereto. For example, step S6-1 may be omitted. With the configuration described above, it is possible to reduce the obstruction of the progress of the game.

Although a case in which one input device 50 is connected to the game device 100 has been described in the above embodiment, the invention is not limited thereto. For example, a plurality of input devices 50 may be connected to the game device 100.

Although a case in which the left grip part, the right grip part, the direction keys, the operation buttons, and the touch pad are provided as examples of the input device 50 has been described in the above embodiment, the invention is not limited thereto. For example, the input device 50 may include a controller with a motion sensor including an acceleration sensor, a gyro sensor, and the like. In addition, along with or instead of the input device 50, the game device 100 may recognize gesture operations of the user U using a camera provided in the device, and may create instruction information on the basis of the recognized result.

Although a case in which the game device 100 reads a program, data, or the like from a ROM medium loaded in the media drive 155 has been described in the above embodiment, the invention is not limited thereto. For example, the game device 100 may download a game application.

Although a case in which, if the determination unit 150b of the game device 100 determines to start measuring the degree of concentration, the derivation unit 150c starts measuring the degree of concentration of the user L each time in a scene of the game has been described in the above embodiment, the invention is not limited thereto. For example, if the determination unit 150b of the game device 100 determines to start measuring the degree of concentration, the derivation unit 150c may start measuring the degree of concentration of the user U in a scene of the game at a predetermined rate or probability.

Although a case in which the output unit 150d displays the information acquired from the derivation unit 150c (the information indicating the reaction speed, information indicating the accuracy, and information indicating the degree of concentration) on the output device 10 has been described in the above embodiment, the invention is not limited thereto. For example, the information derived by the derivation unit 150c (the information indicating the reaction speed, information indicating the accuracy, and information indicating the degree of concentration) may be transmitted to another terminal (not illustrated). In this case, the other terminal receives information transmitted by the game device 100 and outputs the received information. With the configuration described above, in a case in which the user U is a child and the other terminal is a terminal of a parent of the child, the parent can be notified of the reaction speed, the accuracy, and the degree of concentration of the child while the game progresses.

In the above-described embodiment, the output unit 150d is optional, and may be omitted.

As the operation of starting measurement of t degree of concentration, an operation of loading a magazine of a firearm or the like may be applied in the above-described embodiment. In this case, a length (the number of procedures) of the operation of measuring the degree of concentration may vary for each item. With the configuration as described above, it can be associated with complexity in the procedure for a loading operation according to types of items (guns, rifles, and heavy weapons).

According to the game system 1 of the present embodiment, the game device 100 includes the reception unit 150a that receives operation information created when the user U performs an operation on the input device 50 while a game progresses, the determination unit 150b that determines whether an operation of starting measurement of the degree of concentration has been performed on the basis of the operation information received by the reception unit 150a, the derivation unit 150c that starts measuring the degree of concentration if the determination unit 150b determines that the operation of starting measurement of the degree of concentration has been performed and derives the degree of concentration of the user U on the basis of an operation performed by the user U during the started measurement of the degree of concentration, and the output unit 150d that outputs information indicating the degree of concentration derived by the derivation unit.

Changes in scores and win/loss in game are important indexes for the user U and motivate the user U to be enthusiastic about the game. However, aside from the user's own skill, results depend on how the user concentrates on the play. In addition, there is concern that keep playing a game for a long time badly affects the health of the user U. Because measurement of the degree of concentration can be started on the basis of operation information created when the user U performs an operation on the input device 50 while the game progresses in the present embodiment, measurement of the degree of concentration can be encouraged while the game progresses. That is, by incorporating the measurement of the degree of concentration as part of an operation performed during the game, an accurate degree of concentration can be measured without making the user U annoyed. In addition, changes of results may be displayed, and the user U can be encouraged to take a rest or stop the game voluntarily.

In addition, the reception unit 150a receives a cancellation operation of canceling the operation of starting measurement of the degree of concentration, and the game device 100 includes the cancellation unit 150f that cancels the operation of starting measurement of the degree of concentration on the basis of the cancellation operation received by the reception unit 150a. With the configuration described above, the operation of starting measurement of the degree of concentration can be canceled, and thus the game can progress with no need to worry about measurement of the degree of concentration.

In addition, the derivation unit 150c derives the degree of concentration on the basis of at least one or both of the reaction speed and the accuracy of an operation performed by the user U during the measurement of the degree of concentration. With the configuration described above, the degree of concentration in which the reaction speed and accuracy are reflected can be derived, and thus the user U can be encouraged to take a rest or stop the game voluntarily.

### MODIFIED EXAMPLE OF EMBODIMENT

FIG. 1 can be applied to a configuration example of a game system 1a according to a modified example of the embodiment of the present invention. However, a difference is that a game device 100a-1 to a game device 100a-n are provided in place of the game device 100-1 to the game device 100-n, and a game server 200a is provided in place of the game server 200.

Hereinafter, any game device among the game device 100a-1 to the game device 100a-n will be described as a game device 100a. In addition, an input device connected to the game device 100a will be described as an input device 50, and a user using the game device 100a and the input device 50 will be described as a user U.

The user U performs an operation on the input device 50 while the game progresses. The input device 50 detects an operation performed by the user U and creates instruction information including the user ID and information indicating the content of the operation on the basis of the detected operation. The input device 50 outputs the created instruction information to the game device 100a. The game device 100a transmits the instruction information to the game server 200a upon receiving the instruction information output by the input device 50.

The game server 200a receives the instruction information transmitted by the game device 100a and reflects the content of the operation in the game on the basis of the information indicating the content of the operation included in the received instruction information. The game server 200a transmits game information including game data in which the content of the operation is reflected to the game device 100a that has transmitted the instruction information. The game device 100a receives the game information transmitted by the game server 200a and outputs an image and sound of the game on the basis of the game data included in the received game information.

In addition, the game device 100a determines whether an operation of measuring the degree of concentration has been performed on the basis of the received instruction information. If it is determined that an operation of starting measurement of the degree of concentration has been performed, the game device 100a stops progress of the game and starts measuring the degree of concentration by executing a test to measure the degree of concentration.

The input device 50 detects the operation performed by the user U and creates the instruction information on the basis of the detected operation. The input device 50 outputs the created instruction information to the game device 100a. The game device 100a receives the instruction information output by the input device 50. The game device 100a derives the degree of concentration on the basis of the information indicating the content of the operation included in the received instruction information. The game device 100a outputs information indicating the derived degree of concentration.

Among the input device 50, the game device 100a, and the game server 200a included in the game system 1a, the game device 100a and the game server 200a that are different from those in the above embodiment will be described below.

FIG. 2 can be applied to a hardware configuration of the game device 100a.

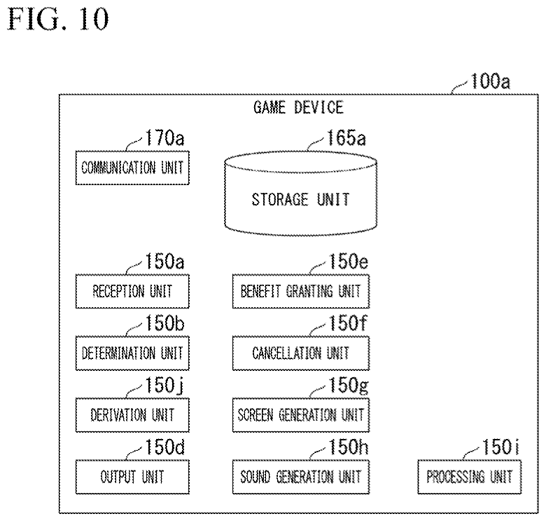

FIG. 10 is a block diagram illustrating an example of a game device according to a modified example of the present embodiment.

The game device 100a includes, for example, a communication unit 170a, a reception unit 150a, a determination unit 150b, a derivation unit 150j, an output unit 150d, a benefit granting unit 150e, a cancellation unit 150f, a screen generation unit 150g, a sound generation unit 150h, a processing unit 150i, and a storage unit 165a.

If the determination unit 150b determines whether information indicating content of an operation included in instruction information received by the reception unit 150a corresponds to an operation of starting measurement of the degree of concentration, the benefit granting unit 150e grants a benefit to the user U who performed the operation corresponding to the instruction information. The benefit granting unit 150e may grant a benefit to the user U immediately or when the game resumes. When granting a benefit, the benefit granting unit 150e creates instruction information including the user ID to whom the benefit is granted and information indicating the benefit to be granted and outputs the created instruction information to the communication unit 170a. The benefit granting unit 150e outputs the information indicating the benefit to be granted to the user U to the output unit 150d. For example, the benefit granting unit 150e may increase the effect of an item or increase the number of obtainable items.

In addition, the benefit granting unit 150e acquires at least one of a reaction speed, an accuracy, and the degree of concentration from the derivation unit 150c, and grants a benefit to the corresponding user U on the basis of at least one of the acquired reaction speed, accuracy, and degree of concentration. The benefit granting unit 150e may grant a benefit to the user U immediately or when the game resumes. When granting a benefit, the benefit granting unit 150e creates instruction information including the user ID to whom the benefit is granted and information indicating the benefit to be granted and outputs the created instruction information to the communication unit 170a. The benefit granting unit 150e outputs the information indicating the benefit to be granted to the user U to the output unit 150d. For example, the benefit granting unit 150e may reflect a high or low degree of concentration in the game. With the configuration described above, the operation to derive the degree of concentration can be incorporated as a part of the game. In addition, for example, the benefit granting unit 150e may increase or decrease the effect of an item or the number of obtainable items on the basis of the accuracy.

The output unit 150d acquires the information indicating the benefit to be granted to the user U output by the benefit granting unit 150e. The output unit 150d displays the acquired information indicating the benefit to be granted to the user U on the output device 10.

If the determination unit 150b determines to start measuring the degree of concentration, the processing unit 150i stops the game and executes a test for measuring the degree of concentration. The processing unit 150i determines whether an operation performed by the user corresponds to a predetermined operation required for the user.

FIG. 4 to FIG. 6 can be applied as examples of the predetermined operation required for the user. The processing unit 150i resumes the game when the test for measuring the degree of concentration ends.

If the determination unit 150b determines to start measuring the degree of concentration, the derivation unit 150j starts measuring the degree of concentration of the user. After starting measuring the degree of concentration, the derivation unit 150j derives the degree of concentration of the user on the basis of the operation performed by the user corresponding to the predetermined operation.

The game server 200a includes an item management unit (not illustrated) in the above-described game server 200. The item management unit manages parameters of items, points, and the like acquired by the user U of the game device 100a. The item management unit acquires the instruction information received by the communication unit 275a and manages parameters of items, points, and the like on the basis of the user ID included in the acquired instruction information and the information indicating a benefit to be granted.

(Operation of Game System 1a)

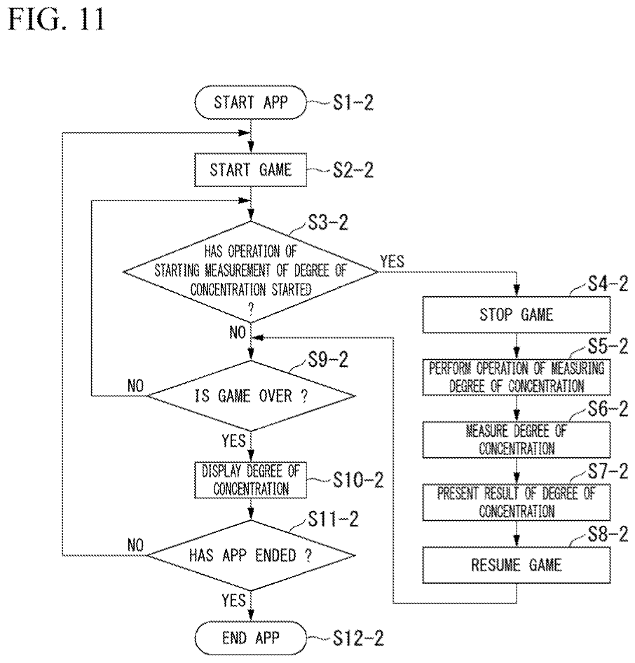

FIG. 11 is a flowchart showing an example of an operation of the game system according to the modified example of the present embodiment.

In FIG. 11, an example of an operation of the game device 100a is mainly shown.

Steps S1-1 to S3-1 of FIG. 9 can be applied to steps S1-2 to S3-2.

(Step S4-2)

If the determination unit 150b of the game device 100a determines to start measuring the degree of concentration, the processing unit 150i stops the game and starts measuring the degree of concentration of the user.

(Step S5-2)

The processing unit 150i of the game device 100a executes a test for measuring the degree of concentration. The processing unit 150i determines whether an operation performed by the user corresponds to the predetermined operation required for the user.

(Step S6-2)

The derivation unit 150j of the game device 100a acquires display time information and acquires reception time information on the basis of the operation performed by the user corresponding to the predetermined operation. The derivation unit 150j derives the time elapsed from the display time to the reception time on the basis of the acquired display time information and reception time information to acquire a reaction speed.

The derivation unit 150j derives an accuracy such as a correct answer rate on the basis of the operation performed by the user corresponding to the predetermined operation.

(Step S7-2)

If the determination unit 150b of the game device 100a determines that the operation of starting measurement of the degree of concentration has been performed on the basis of the instruction information received by the reception unit 150a, the benefit granting unit 150e grants a benefit to the user who performed the operation corresponding to the instruction information. The benefit granting unit 150e outputs the information indicating the benefit to be granted to the user to the output unit 150d.

The output unit 150d acquires the information indicating the benefit to be granted to the user output by the benefit granting unit 150e. The output unit 150d displays the acquired information indicating the benefit to be granted to the user on the output device 10.

(Step S8-2)

When the test for measuring the degree of concentration ends, the processing unit 150i of the game device 100a resumes the game.

Steps S7-1 to S10-1 of FIG. 9 can be applied to steps S9-2 to S12-2.

Although a case in which the information indicating the benefit to be granted to the user U is displayed on the output device 10 in step S7-2 has been described in FIG. 11, the invention is not limited thereto. For example, a measurement result of the degree of concentration may be displayed on the output device 10. In addition, step S7-2 may be omitted. With the configuration described above, obstruction of progress of the game can be reduced.

Although a case in which the game device 100a grants a benefit to the corresponding user U if the instruction information corresponds to the operation of starting measurement of the degree of concentration and grants a benefit to the user on the basis of at least one of the reaction speed, the accuracy, and the degree of concentration has been described in the embodiment above, the invention is not limited thereto. For example, the game device 100a may grant a benefit to the corresponding user U in either a case in which the instruction information corresponds to the operation of starting measurement of the degree of concentration or a case in which a benefit is grated on the basis of at least one of the reaction speed, the accuracy, and the degree of concentration.

According to the game system 1a of the modified example of the present embodiment, the game device 100a further includes the benefit granting unit 150e that grants a benefit to the user U on the basis of either or both of a case in which the operation of starting measurement of the degree of concentration has been performed and the degree of concentration derived by the derivation unit 150c, in addition to the configuration of the game device 100 of the embodiment. With the configuration described above, a benefit can be granted to the user U on the basis of either or both of the case in which the operation of starting measurement of the degree of concentration has been performed and the degree of concentration, and thus measurement of the degree of concentration can be encouraged while the game progresses. In addition, it is possible to encourage the user U to perform measurement stably by providing an advantage according to the result of the measurement on the basis of the degree of concentration in the game.

In addition, the processing unit 150i that executes the test for measuring the degree of concentration if the determination unit 150b determines that the operation to start measurement of the degree of concentration has been performed is further provided. With the configuration described above, the degree of concentration can be measured in an event other than scenes of the game, and thus it is possible to focus on the measurement of the degree of concentration more.

Although the embodiment and the modified example of the present invention have been described in detail above referring to the drawings, a specific configuration is not limited to the embodiment and the modified example and includes an amendment to a design that falls within the scope that does not depart from the gist of the present invention. The embodiment and modified example thereof can be implemented in other various modes, and can be subject to various omission, replacement, modification, and combination within the scope not departing from the gist of the invention. The embodiment and modified example thereof are included in the scope and gist of the invention, and at the same time, included in the inventions described in the claims and equivalents thereof.

For example, a computer program for realizing the functions of each device described above may be recorded in a computer readable recording medium, and the computer program recorded in the recording medium may be read by a computer system to be executed. Further, the “computer system” mentioned here may include an OS and hardware such as a peripheral apparatus.

In addition, the “computer-readable recording medium” refers to a writable non-volatile memory such as a flexible disk, a magneto-optical disk, a ROM, or a flash memory, a portable medium such as a digital versatile disc (DVD), or a storage device such as a hard disk built into the computer system.

Moreover, the “computer-readable recording medium” may include a medium that retains a program for a certain time period, like a volatile memory (e.g., a dynamic random access memory (DRAM)) within the computer system for functioning as a server or a client in a case in which a computer program is transmitted over a network such as the Internet or over a communication line such as a telephone line.

In addition, the program may be transmitted to another computer system from the computer system saving the program in a storage device, or the like via a transmission medium or by transmission waves in a transmission medium. Here, the “transmission medium” for transmitting the program refers to a medium with the function of transmitting information such as a network (communication network) like the Internet or a communication line such as a telephone line.

In addition, the program may realize some of the above-described functions. Furthermore, the program may be a so-called differential file (differential program) that can realize the above-described functions in combination of a program already recorded in the computer system.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1, 1a Game system
10 Output device
50-1, . . . , 50-n, 50a-l, . . . , 50a-n, 50, 50a Input device
100-1, . . . , 100-n, 100a-1, . . . , 100a-n, 100, 100a Game device
110 System controller
120 Clock
130 Device controller
140 Subsystem
150 Main system
150a Reception unit
150b Determination unit
150c, 150j Derivation unit
150d Output unit
150e Benefit granting unit
150f Cancellation unit
150g Screen generation unit
150h Sound generation unit
150i Processing unit
155 Media drive
160 USB module
165 Flash memory
165a Storage unit
170 Wireless communication module
170a Communication unit
175 Wired communication module
200 Game server
275a Communication unit
250a Player management unit
250b Game control unit
250h Storage unit
250i Player DB

What is claimed is:

1. A game device comprising:
a reception unit that is configured to receive operation information created when a user performs an operation on an input device while a game progresses;
a determination unit that is configured to determine whether an operation of starting measurement of a degree of concentration has been performed on the basis of the operation information received by the reception unit; and
a derivation unit that is configured to start measuring a degree of concentration if the determination unit determines that the operation of starting measurement of a degree of concentration has been performed and derive a degree of concentration of the user on the basis of an operation performed by the user during the started measurement of a degree of concentration.

2. The game device according to claim 1, further comprising:
a benefit granting unit that grants a benefit to the user on the basis of either or both of a case in which the operation of starting measurement of a degree of concentration has been performed and the degree of concentration derived by the derivation unit.

3. The game device according to claim 1,
wherein the reception unit is configured to receive a cancellation operation of canceling the operation of starting measurement of a degree of concentration, and
wherein a cancellation unit that is configured to cancel the operation of starting measurement of a degree of concentration on the basis of the cancellation operation received by the reception unit is provided.

4. The game device according to claim 1, wherein the derivation unit is configured to derive the degree of concentration on the basis of either or both of a reaction speed and an accuracy of the operation performed by the user during the measurement of a degree of concentration.

5. The game device according to claim 1, further comprising:
a processing unit that is configured to execute a test for measuring a degree of concentration if the determination unit determines that the operation of starting measurement of a degree of concentration has been performed.

6. A method comprising:
receiving operation information created when a user performs an operation on an input device while a game progresses;
determining whether an operation of starting measurement of a degree of concentration has been performed on the basis of the operation information; and
starting measuring a degree of concentration if it is determined that the operation of starting measurement of a degree of concentration has been performed and deriving a 20 degree of concentration of the user on the basis of an operation performed by the user during the started measurement of a degree of concentration.

7. The method of claim 6, further comprising:
granting a benefit to the user on the basis of either or both of a case in which the operation of starting measurement of a degree of concentration has been performed and the degree of concentration derived.

8. The method of claim 6, wherein the receiving includes receiving a cancellation operation of canceling the operation of starting measurement of a degree of concentration, and
the method further comprising cancelling the operation of starting measurement of a degree of concentration on the basis of the cancellation operation.

9. The method of claim 6, wherein the deriving includes deriving the degree of concentration on the basis of either or both of a reaction speed and an accuracy of the operation performed by the user during the measurement of a degree of concentration.

10. The method of claim 6, further comprising:
executing a test for measuring a degree of concentration if it is determined that the operation of starting measurement of a degree of concentration has been performed.

11. A non-transitory computer readable medium, storing a program causing a computer to execute:
receiving operation information created when a user performs an operation on an input device while a game progresses;
determining whether an operation of starting measurement of a degree of concentration has been performed on the basis of the operation information; and
starting measuring a degree of concentration if it is determined that the operation of starting measurement of a degree of concentration has been performed and deriving a degree of concentration of the user on the basis of an operation performed by the user during the started measurement of a degree of concentration.

12. The non-transitory computer readable medium of claim 11, storing a program causing the computer to execute:
granting a benefit to the user on the basis of either or both of a case in which the operation of starting measurement of a degree of concentration has been performed and the degree of concentration derived.

13. The non-transitory computer readable medium of claim 11, wherein the receiving includes receiving a cancellation operation of canceling the operation of starting measurement of a degree of concentration, and
the non-transitory computer readable medium further storing a program causing the computer to execute:
cancelling the operation of starting measurement of a degree of concentration on the basis of the cancellation operation.

14. The non-transitory computer readable medium of claim 11, wherein the deriving includes deriving the degree of concentration on the basis of either or both of a reaction speed and an accuracy of the operation performed by the user during the measurement of a degree of concentration.

15. The non-transitory computer readable medium of claim 11, further storing a program causing the computer to execute:
executing a test for measuring a degree of concentration if it is determined that the operation of starting measurement of a degree of concentration has been performed.
